(19) United States
(12) Patent Application Publication
(10) Pub. No.: US 2017/0117527 A1
(43) Pub. Date: Apr. 27, 2017

(54) BATTERY MODULE COVER PROVIDED WITH AN ELECTRICAL CONNECTION CLIP

(71) Applicant: RENAULT s.a.s., Boulogne-Billancourt (FR)

(72) Inventors: Sylvain BONNARD, Rouen (FR); Frederic GAMARD, Montaure (FR); Herve BIANEIS, Montigny le Bretonneux (FR)

(73) Assignee: RENAULT s.a.s., Boulogne-Billancourt (FR)

(21) Appl. No.: 15/303,107

(22) PCT Filed: Mar. 27, 2015
(86) PCT No.: PCT/FR2015/050789

§ 371 Date: Dec. 21, 2016

(30) Foreign Application Priority Data
Apr. 11, 2014 (FR) 1453262

(51) Int. Cl. H01M 2/26; H01M 10/0525; B60L 11/18; H01M 10/42; H01M 10/48; H01M 2/10; H01M 2/30

(52) U.S. Cl. CPC H01M 2/26; H01M 2/1077; H01M 10/0525; H01M 2/305; H01M 10/425; H01M 10/482; B60L 11/1879; H01M 2010/4271; H01M 2220/20; B60Y 2410/115; B60Y 2410/113; B60Y 2400/112

(57) ABSTRACT

A cover for a battery module includes an inner face whereon at least one electrical connection clip is mounted. The clip cooperates electrically with a corresponding measurement terminal of the battery module when the cover is coupled to the battery module.

### TECHNICAL DOMAIN OF THE INVENTION

The invention relates to the domain of connections on battery modules.

The object of the invention is more particularly a battery module cover provided with an electrical connection clip.

### PRIOR ART

In the domain of batteries, a battery module generally comprises a plurality of cells. Each of these cells generally comprises two connection terminals allowing said cells to be connected in series and/or in parallel.

Such batteries can, for example, be used in the domain of motor vehicles.

In order best to manage the battery module, it can be advantageous to monitor the behavior of one cell in particular (or several cells), and preferably that of each of the cells, for example by measuring a voltage at a chosen location of the battery module.

In that sense, the prior art discloses that the cells can be electrically connected together in series and/or in parallel by a connection unit 1 (FIG. 1), also known as a bus bar in the domain. The connection unit 1 comprises two lugs 1a, 1b, generally welded by ultrasound respectively to a terminal of a first cell of the module and to a terminal of a second cell of the module. The connection unit 1 then comprises a male component 2 whereon a female component 3 is mounted. The female component 3 is associated for its part with a connection wire 4 routed to a “Battery Management System” also known as BMS in the domain.

Such a solution necessitates an intervention on each of the connection units one wishes to connect to the BMS. This results in the existence of a multitude of parts to assemble, low compactness, low robustness of quality of a safety function and a high manual assembly cost.

### OBJECT OF THE INVENTION

The aim of this invention is to propose a sol ion that remedies all or some of the disadvantages listed above.

One moves towards this aim thanks to a cover for a battery module, said cover comprising an inner face whereon at least one electrical connection clip is mounted, said clip being designed to cooperate electrically with a corresponding measurement terminal of the battery module when the cover is coupled to the battery module.

In particular, the cover can comprise an electrical connector electrically connected to said at least one electrical connection clip, said electrical connector being placed on an outer face of the cover.

For example, said at least one electrical connection clip is connected to said electrical connector by an electrically conducting track printed on the inner face or enclosed in the wall of the cover between the inner and outer faces.

The cover preferably comprises, at said at least one electrical connection clip, at least one opening designed for passing a tool allowing said electrical connection clip to be varied between a closed configuration of the electrical connection clip and an open configuration of the electrical connection clip.

The electrical connection clip can be formed so as to have a return motion force constantly pulling said electrical connection clip towards its closed configuration.

According to one embodiment, said a least one electrical connection clip comprises:
a base mounted on the inner face,
two clipping blades extending in a converging manner one towards the other from said base, in a direction opposite the inner face so as to form a clipping zone of the corresponding measurement terminal,
two tongue-like strips each extending respectively from one end of one of the clipping blades distant from said base,
two concave parts, each delimited by a corresponding clipping blade and a corresponding tongue-like strip, each concave part facing an opening made in the cover and connecting the inner face of the cover to the outer face of the cover.

The invention also relates to a device comprising a battery module equipped with at least one measurement terminal and a cover such as described, said at least one electrical connection clip of the cover clipping said at least one corresponding measurement terminal when the cover is coupled to the battery module.

The device can comprise an assembly or disassembly configuration of the cover, wherein said at least one electrical connection clip is held open, in particular by an appropriate tool, at least one part of which passes through the cover, while said at least one corresponding measurement terminal is inserted into a clipping zone of said at least one electrical connection clip, and while no contact is made between said at least one electrical connection clip and said at least one corresponding measurement terminal.

The battery cells can be connected in series and/or in parallel by connection units, each connection unit that contributes to a series connection of the electric connections scheme of the battery module cells being equipped with a measurement terminal, and the cover comprises as many electrical connection clips as the battery module has measurement terminals, each of the electrical connection clips clipping a single corresponding measurement terminal.

The invention also relates to an assembly process of a device such as that described and comprising the following steps:
procurement of the battery module,
procurement of the cover,
coupling of said cover to said battery module such that at the end of the coupling step, said at least one electrical connection clip provides an electrical contact with said at least one corresponding measurement terminal.

The coupling step preferably comprises the following successive steps:
activation of said at least one electrical connection clip so as to hold it in the open position in order to create a zone for inserting said at least one measurement terminal,
converging the cover with the battery module so as to insert said at least one corresponding measurement terminal in said insertion zone,
relaxing the activation of said at least one electrical connection clip such that it closes over said at least one corresponding measurement terminal.

The process can furthermore comprise a step of using a tool making it possible to implement the activation step of said at least one electrical connection clip, said tool comprising units mounted to be mobile one relative to the other so as to have variable bracing, and the step of using the tool comprises the following steps:
insertion, from the outer face of the cover, of each of the two units into an opening that is associated with it and links the outer face of the cover to the inner face of the cover,
a change to the bracing of the two units such that the interaction of said two units with said at least one electrical connection clip, on the side of the inner face of the cover, causes said at least one electrical connection clip to open.

The invention also relates to a process for using a device such as that described comprising a step for measuring a physical parameter of the battery module, in particular a voltage, using said at least one electrical connection clip.

The invention also relates to a motor vehicle comprising a device such as that described and a system for monitoring the battery module electrically connected to said at least one electrical connection clip. The vehicle can comprise a coupled electric motor for driving at least one wheel of the vehicle, said motor being electrically powered by the battery module.

### BRIEF DESCRIPTION OF THE DRAWINGS

Further advantages and characteristics will emerge more clearly from the description that will follow of particular embodiments of the invention given as non-limitative examples and illustrated on the attached drawings, wherein:

FIG. 1 illustrates a connection unit of a battery module according to the prior art,

FIG. 2 is a perspective view of a cover according to a particular embodiment of the invention,

FIG. 3 illustrates a battery module comprising sixteen battery cells and designed to cooperate with the cover of FIG. 2,

FIG. 4 is a partial perspective view of the battery module of FIG. 3, the top part illustrating the first six left hand cells of FIG. 3,

FIG. 5 illustrates an electrical connection clip mounted on the cover 100 in a closed position on the left hand side of FIG. 5, and in an open position on the right hand side of FIG. 5, the arrow in the center illustrating the passage from the closed position to the open position,

FIG. 6 illustrates a detailed perspective view of an electrical connection clip,

FIG. 7 illustrates a battery module whereon the cover is mounted in an assembly or disassembly phase of said cover.

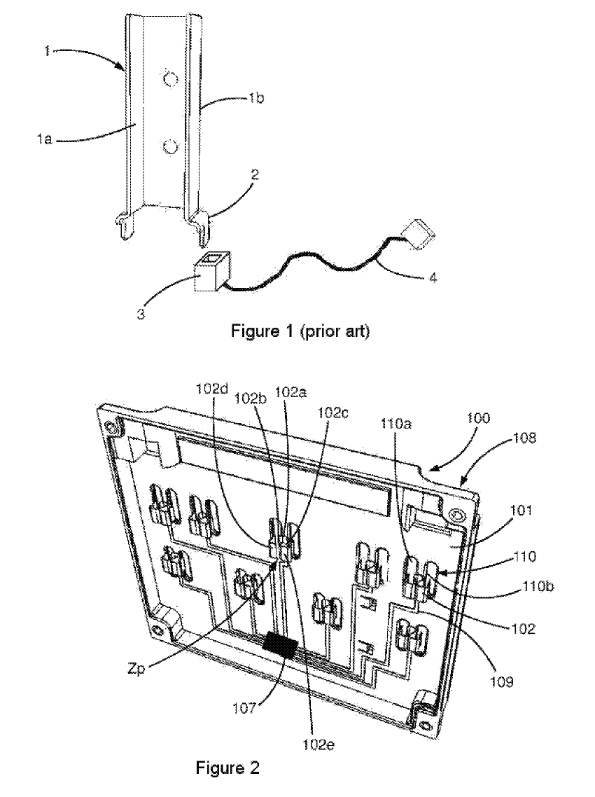

### DESCRIPTION OF PREFERRED EMBODIMENTS OF THE INVENTION

The invention described below differs from the prior art particularly in that it proposes a cover for a battery module equipped with a clip judiciously arranged.

As FIG. 2 illustrates, the cover 100 for a battery module comprises an inner face 101 whereon at least one electrical connection clip 102 is mounted, Said electrical connection clip 102 is designed to cooperate electrically with a corresponding measurement terminal of the battery module when the cover is coupled to the battery module. The measurement terminal is designed to contribute to taking an electrical measurement on the battery module.

The cover 100 is therefore understood to comprise means capable of cooperating with the battery module in order to assemble the cover 100 to the battery module, in particular to a housing of the battery module.

Each electrical connection clip 102 is preferably fixed to the cover 100 by means of snap head rivets or compound-filled in the cover 100 if the latter is in a plastic material.

In particular, the cover 100 comprises, as the example of FIG. 2 illustrates, a plurality of electrical connection clips 102, each of said electrical connection clips 102 being designed to cooperate with an associated measurement terminal of the battery module.

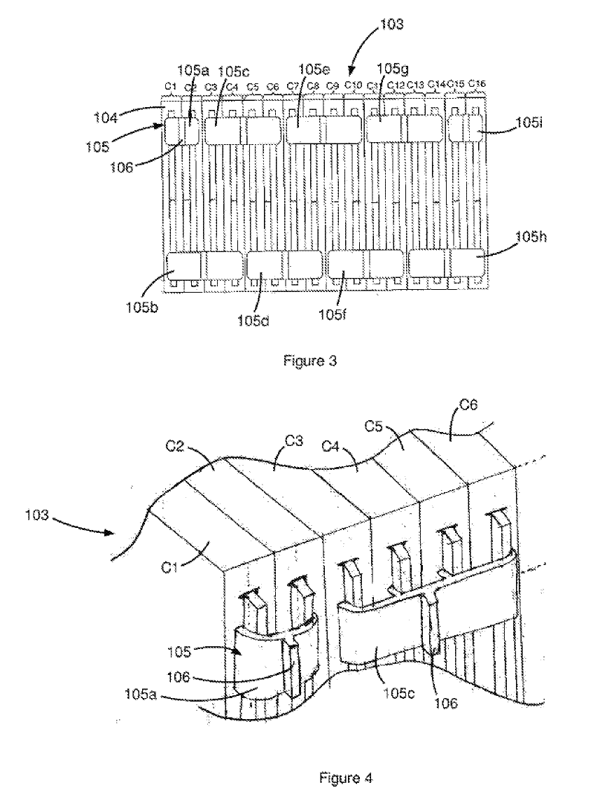

FIGS. 3 and 4 illustrate the battery module 103 whereon the cover 100 of FIG. 2 will be mounted.

The battery module 103 can comprise a plurality of cells 104 connected together in series and/or in parallel, particularly by using connection units 105 (or bus bars). Each cell then forms a unit for storing energy configured so as to return it (or to recover some of it) on demand. The electrical scheme of the connections between the cells makes it possible to obtain a compromise among the parameters voltage/current/capacity of the battery module.

FIGS. 3, 4 and 7 in particular illustrate a device equipped with the battery module 103, equipped with at least one measurement terminal 106. The device furthermore comprises the cover 100 as described in this description but not illustrated on FIGS. 3 and 4 due to concerns for clarity. In a configuration where the cover 100 is coupled to the module, said at least one electrical connection clip 102 of the cover 100 clips said at least one associated measurement terminal 106.

According to the particular example of FIG. 3, part of which is illustrated in perspective on FIG. 4, the battery module 103 comprises sixteen cells C1, C2, C3, C4, C5, C6, C7, C8, C9, C10, C11, C12, C13, C14, C15, C16 arranged in eight couples of two cells connected in parallel (C1, C2), (C3, C4), (C5, C6), (C7, C8), (C9, C10), (C11, C12), (C13, C14), (C15, C16), said couples being connected together in series. Apart from the two end couples of the series, the same connection unit 105b, 105c, 105d, 105e, 105f, 105g connects at the same time two cells of a first couple of cells and two cells of a second couple of cells, and therefore makes a series connection between the first and second couples of cells, while contributing to the parallel connection of the first couple of cells and the parallel connection of the second couple of cells. In this example, the cover 100 of FIG. 2 comprises nine clips 102, each designed to clip a corresponding measurement terminal 106. The nine connection terminals 106 are distributed such that each one belongs to a connection unit 105b, 105c, 105d, 105e, 105f, 105g, 105h. Furthermore, two additional connection units 105a, 105i, respectively associated with the end couples of cells of the series of couples of cells, also each comprises a measurement terminal 106. Of course, this is only a particular example that a specialist will be able to adapt according to the needs, for example by playing on the number of cells and the electric scheme that connects them.

In other words, the device is understood to comprise a battery module with several cells interconnected in series and/or in parallel, and at least one, or several, measurement terminals 106. Connection units, in particular welded to the terminals of the battery module cells, preferably make electrical connections in series and/or in parallel. Each measurement terminal is advantageously integrated with a corresponding connection unit. Each measurement terminal is preferably flat of the TAB type. The device furthermore comprises the cover 103 equipped on its inner face 101 with at least one electrical connection clip 102. Each connection clip 102 is placed on the inner face 101 of the cover such that, when the cover is in the coupled position, the clip is situated opposite a corresponding measurement terminal 106, and as soon the cover 100 is closed over the battery module, said electrical connection clip 102 clips said corresponding measurement terminal 106.

According to a particular embodiment, the battery cells are connected in series and/or in parallel by connection units 105, each connection unit 105 that contributes to a series connection of the electric connections scheme of the battery module cells being equipped with a measurement terminal 106, and the cover 100 comprises as many electrical connection clips 102 as the battery module 103 has measurement terminals 106, each of the electrical connection clips 102 clipping a single corresponding measurement terminal 106.

The cover 100 preferably comprises an electrical connector 107 electrically connected to said at least one electrical connection clip 102, said electrical connector 107 being placed on an outer face 108 of the cover 100. In other words, the electrical connector 107 can comprise male and/or female pins via the outer face 108. This makes it possible, once the cover is in place, to have only one connection unit between the electrical connector 107 and a battery module management unit or BMS (not illustrated). Of course, in a case where the cover 100 comprises a plurality of electrical connection clips 102, each one can be connected to a separate pin of the electrical connector 107. This makes it possible in particular to improve compactness and the number of parts to handle compared with the prior art.

According to one embodiment (FIG. 2), the cover 100 is such that said at least one electrical connection clip 102 is connected to said electrical connector 107 by an electrically conducting track 109 printed on the inner face 101 or enclosed in the wall of the cover 100 between the inner and outer faces of the cover. Each clip 102 is preferably connected, by an electrically conducting track 109 printed on the inner face 101 of the cover 100, to the electrical connector 107 that belongs to it.

In order to facilitate holding each electrical connection clip 102 in position on the associated measurement terminal 106, the electrical connection clip 102 is formed so as to have a return motion force constantly pulling said electrical connection clip 102 towards its closed configuration. When the electrical connection clip 102 is in a configuration of clipping an associated measurement terminal 106, the return motion force still exerts a force tending to press the electrical connection clip 102 onto the measurement terminal 106.

Each electrical connection clip 102 can be formed so as to open when it is pressed against the associated measurement terminal 106 and when the cover 100 converges with the battery module. In this case, each measurement terminal 106 has a penetrating shape complementing the electrical connection clip 102 such that the convergence of the cover 100 and the battery module 103 induces, via the interaction of the penetrating shape with the electrical connection clip 102, an opening of the electrical connection clip 102.

Alternatively, in order to facilitate the opening and closing of an electrical connection clip 102, the cover 100 can comprise, at said at least one (and preferably at each) electrical connection clip 102, at least one opening 110, (preferably two openings 110a, 110b), designed for passing a tool 111 (FIG. 5) allowing said electrical connection clip 102 to be varied between a closed configuration (left hand part of FIG. 5) of the electrical connection clip 102 and an open configuration (right hand part of FIG. 5) of the electrical connection clip 102. It is understood here that the tool is designed to be used on the side of the outer face 108 of the cover 100.

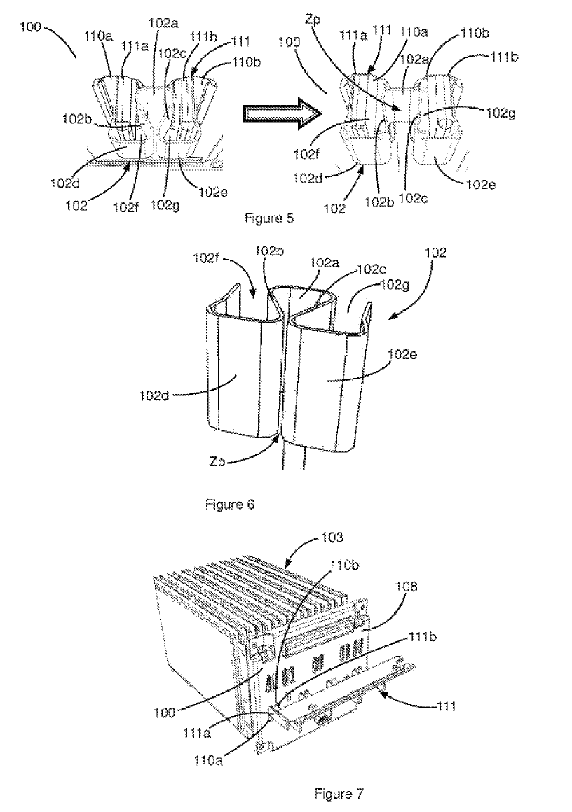

According to a preferred embodiment illustrated on FIGS. 2 and 6, said at least one electrical connection clip 102 (and preferably each electrical connection clip 102) comprises:
a base 102a mounted on the inner face 101 of the cover 100,
two clipping blades 102b, 102c extending in a converging manner one towards the other from said base 102a, in a direction opposite the inner face 101 so as to form a clipping zone Zp of the corresponding measurement terminal 106,
two tongue-like strips 102d, 102e each extending respectively from one end of one of the clipping blades 102b, 102c distant from said base 102a,
two concave parts 102f, 102g, each delimited by a corresponding clipping blade 102b, 102c and a corresponding tongue-like strip 102d, 102e (associated with said clipping blade 102b, 102c), each concave part 102f, 102g facing an opening 110a, 110b made in the cover 100 and connecting the inner face 101 of the cover 100 to the outer face 108 of the cover 100.

More particularly, for each electrical connection clip 102, the openings 109a, 109b associated with said electrical connection clip 102 are formed on either side of a zone of the cover 100 accommodating the base 102a of the connection clip 102.

It is therefore understood that in a general manner, in the context of the device, the latter comprises an assembly or disassembly configuration of the cover 100, wherein said at least one (and preferably each) electrical connection clip 102 is held open, in particular by an appropriate tool 111 (FIG. 7), at least one part of which passes through the cover 100, while said at least one corresponding measurement terminal 106 is inserted into the clipping zone Zp (FIG. 5) of said at least one electrical connection clip 102 and while no contact is made between the electrical connection clip 102 and said at least one corresponding measurement terminal 106.

When the cover 100 comprises a plurality of electrical connection clips 102 mounted on the inner face 101 of the cover and each one designed to cooperate with a corresponding measurement terminal 106, all the clips 102 are preferably held open simultaneously. This makes it possible substantially to facilitate the coupling of the cover 100 with the battery module 103.

The invention also relates to an assembly process of a device such as that described, said process comprising a step of procuring the battery module 103 as described, a step of procuring a cover 100 as described, and a step of coupling said cover 100 to said battery module 103 such that at the end of the coupling step, said at least one electrical connection clip 102 provides an electrical contact with said at least one corresponding measurement terminal 106.

The result of what has been said previously, in particular preferably when the electrical connection clip is constantly pulled towards its closed position, is that the coupling step preferably comprises the following successive steps:
activation of said at least one electrical connection clip 102 (preferably each electrical connection clip and simultaneously) so as to hold it in the open position in order to create a zone for inserting the corresponding measurement terminal 106 into said at least one electrical connection clip 102,
converging the cover 100 with the battery module so as to insert the measurement terminal 106 in said insertion zone,
relaxing the activation of said at least one electrical connection clip 102 such that it closes, preferably naturally thanks to the return motion force of the electrical connection clip 102, over said at least one corresponding measurement terminal 106.

In particular, the process comprises a step of using a tool 111 (FIGS. 5 and 7) making it possible to implement the activation step of said at least one electrical connection clip 102, said tool 111 comprising units 111a, 111b mounted to be mobile one relative to the other so as to have variable bracing, and the step of using the tool comprises the following steps:
insertion from the outer face 108 of the cover 100 of each of the two units 111a, 111b into an opening 110a, 110b that is associated with it and links the outer face 108 of the cover 100 to the inner face of the cover 100,
a change to the bracing of the two units 111a, 111b such that the interaction of said two units 111a, 111b with said at least one electrical connection clip 102, on the side of the inner face 101 of the cover 100, causes said at least one electrical connection clip 102 to open.

When the cover 100 comprises a plurality of electrical connection clips 102, the tool 111 preferably comprises a plurality of couples of units 111a, 111b configured so as to interact simultaneously with all or some (at least two) of the clips 102 of the plurality of clips. Said couples of units are connected together such that the variation of the bracing of one of the couples of units results in the same variation for all the other couples of units.

Resulting from all that has been said above are the following advantages,
few parts to assemble
connection with a view to taking voltage measurements during an assembly step,
possibility of automated assembly,
good compactness of a voltage measurement function at the battery module cells,
Robust quality.

The use of the disclosures described makes it possible to generate savings with regard to manufacturing the device in terms of raw materials and in terms of assembly steps.

The invention also relates to a process for using a device such as that described. The process comprises a step for measuring a physical parameter of the battery module, in particular a voltage, using said at least one electrical connection clip 102. The measured physical parameter is preferably representative of a measurement taken at the terminals of a single cell of the battery module 103 or at the terminals of a subassembly of cells of the battery module 103. From then on, it is understood that depending on the utilization of the battery module, the specialist will place the connection clips 102 and measurement terminals 106 at locations appropriate to the utilization requirements.

A motor vehicle can furthermore comprise a device such as that described and a system (BMS) for monitoring the battery module, said system being connected to said at least one electrical connection clip with a view to using it for taking a measurement of a physical parameter of the battery module. The vehicle comprises in particular a coupled electric motor in order to drive at least one wheel of the vehicle, said motor being electrically powered by the battery module.

Each cell of the battery module can be a cell comprising lithium.

In this description, a battery module with a single cover has been described. This embodiment is not limitative and the device can comprise several covers of the same type, arranged for example on different faces of the battery module such that each cover is equipped with at least one electrical connection clip, clipping, on the corresponding face, a corresponding measurement terminal.

1-15. (canceled)

16. A cover for a battery module, said cover comprising:
an inner face whereon at least one electrical connection clip is mounted, said clip being configured to cooperate electrically with a corresponding measurement terminal of the battery module when the cover is coupled to the battery module.

17. The cover as claimed in claim 16, further comprising an electrical connector electrically connected to said at least one electrical connection clip, said electrical connector being placed on an outer face of the cover.

18. The cover as claimed in claim 17, wherein said at least one electrical connection clip is connected to said electrical connector by an electrically conducting track printed on the inner face or enclosed in the wall of the cover between the inner and outer faces.

19. The cover as claimed in claim 16, further comprising at least one opening configured to pass a tool allowing said electrical connection clip to be varied between a closed configuration of the electrical connection clip and an open configuration of the electrical connection clip.

20. The cover as claimed in claim 16, wherein the electrical connection clip is configured so as to have a return motion force constantly pulling said electrical connection clip towards a closed configuration.

21. The cover as claimed in claim 16, wherein said at least one electrical connection clip comprises:
a base mounted on the inner face,
two clipping blades extending in a converging manner one towards the other from said base, in a direction opposite the inner face so as to form a clipping zone of the corresponding measurement terminal,
two tongue-like strips, each extending respectively from one end of one of the clipping blades distant from said base, and
two concave parts, each delimited by a corresponding clipping blade and a corresponding tongue-like strip, each concave part facing an opening made in the cover and connecting the inner face of the cover to the outer face of the cover.

22. A device, comprising:
a battery module equipped with at least one measurement terminal and the cover as claimed in claim 16, said at least one electrical connection clip of the cover clipping said at least one corresponding measurement terminal when the cover is coupled to the battery module.

23. The device as claimed in claim 22, further comprising an assembly or disassembly configuration of the cover, wherein said at least one electrical connection clip is held open by a tool, at least one part of which passes through the cover, while said at least one corresponding measurement terminal is inserted into a dipping zone of said at least one electrical connection clip and while no contact is made between said at least one electrical connection clip and said at least one corresponding measurement terminal.

24. The device as claimed in claim 23, wherein cells of the battery are connected in series and/or parallel by connection units, each connection unit that contributes to a series connection of the electric connections scheme of the battery module cells being equipped with a measurement terminal, and wherein the cover comprises as many electrical connection clips as the battery module has measurement terminals, each of the electrical connection clips clipping a single corresponding measurement terminal.

25. An assembly process of the device as claimed in claim 22, comprising:
procuring the battery module;
procuring the cover; and
coupling said cover to said battery module such that at the end of the coupling, said at least one electrical connection clip provides an electrical contact with said at least one corresponding measurement terminal.

26. The process as claimed in claim 25, wherein coupling comprises the following successive steps:
activating said at least one electrical connection clip so as to hold said at least one electrical connection clip in the open position in order to create a zone for inserting said at least one measurement terminal,
converging the cover with the battery module so as to insert said at least one corresponding measurement terminal in said insertion zone, and
relaxing the activation of said at least one electrical connection clip such that said at least one electrical connection clip closes over said at least one corresponding measurement terminal.

27. The process as claimed in claim 26, further comprising:
using a tool to implement the activating of said at least one electrical connection clip, said tool comprising units mounted to be mobile one relative to the other so as to have variable bracing, and the using the tool comprises the following steps:
inserting, from the outer face of the cover, of each of the two units into an opening that is associated with the unit and links the outer face of the cover to the inner face of the cover, and
changing the bracing of the two units such that the interaction of said two units with said at least one electrical connection clip, on the side of the inner face of the cover, causes said at least one electrical connection clip to open.

28. A process for using the device as claimed in claim 22, comprising:
measuring a physical parameter of the battery module using said at least one electrical connection clip.

29. The process as claimed in claim 28, wherein the parameter of the battery is a voltage.

30. A motor vehicle, comprising:
the device as claimed in claim 22; and
a system for monitoring the battery module electrically connected to said at least one electrical connection clip.

31. The motor vehicle as claimed in claim 30, further comprising:
a coupled electric motor to drive at least one wheel of the vehicle, said motor being electrically powered by the battery module.
